(19) United States
(12) Patent Application Publication
(10) Pub. No.: US 2024/0170643 A1
(43) Pub. Date: May 23, 2024

(54) METHOD OF FABRICATING A PRE-LITHIATED ELECTRODE AND LITHIUM-ION BATTERY CELL

(71) Applicant: Lilium eAircraft GmbH, Wessling (DE)

(72) Inventors: Felix Scheile, München (DE); Tanja Zünd, Egmating (DE); Roman Krafft, Reutlingen (DE); Armin Ader, Schrobenhausen Edelshausen (DE); Richard Rauen, München (DE)

(21) Appl. No.: 18/494,985

(22) Filed: Oct. 26, 2023

(30) Foreign Application Priority Data
Nov. 21, 2022 (EP) 22208678.7

(51) Int. Cl. H01M 4/134; H01M 4/04; H01M 4/131; H01M 4/133; H01M 4/1393; H01M 4/1395; H01M 10/0525

(52) U.S. Cl. CPC H01M 4/134; H01M 4/0435; H01M 4/131; H01M 4/133; H01M 4/1393; H01M 4/1395; H01M 10/0525; H01M 2004/027

(57) ABSTRACT

A method of fabricating a pre-lithiated electrode comprises: disposing a Li-PET sheet comprising a layer of lithium metal adjacent to a prefabricated electrode comprising a layer of anode material; contacting a surface of the layer of anode material with a surface of the layer of lithium metal; and calendering the layer of lithium metal and the prefabricated electrode together. The present disclosure further provides a lithium-ion battery cell comprising such pre-lithiated electrode.

### PRIORITY CLAIM

This application claims the benefit of the filing date of European Patent Application Serial No. EP22208678.7, filed Nov. 21, 2022, for “Method of fabricating a pre-lithiated electrode and lithium-ion battery cell,” the disclosure of which is incorporated herein in its entirety by this reference.

### TECHNICAL FIELD

The present disclosure is directed to a method of fabricating a pre-lithiated electrode and a lithium-ion battery cell comprising the pre-lithiated electrode.

### BACKGROUND

Lithium (aLi) ion batteries have played a role in the development of current generation mobile devices, microelectronics and electric vehicles. A typical Li-ion battery is made of a positive electrode (cathode), a negative electrode (anode), an electrolyte to conduct ions, a porous separator membrane, which is generally an electrical insulator, between the two electrodes to keep them physically apart, and a surrounding packaging.

The rapid advancement and complex requirements of the energy storage industry requires lithium-ion batteries with improved energy density and cycle life. The improved energy density can be achieved with anodes containing silicon or silicon oxide. The drawback of this material is a higher demand of lithium leading to reduced cycle life, i.e., less cyclable lithium. Reduced cyclable lithium results in a reduced usable cell capacity. The addition of lithium during lithium-ion battery production, known as pre-lithiation, is used to compensate for these lithium losses.

Various anode pre-lithiation methods exist including chemical pre-lithiation, electrochemical pre-lithiation, and stabilized lithium metal powder.

US 2022/0052307 A1 discloses an in-line contact pre-lithiation. Further, the application of thin lithium foil for direct contact pre-lithiation of anodes within lithium ion battery production is disclosed by Benedikt Stumper et al., Procedia CIRP 93(2020), 156-161.

The problem underlying the present disclosure is to provide an improved method for fabricating a pre-lithiated electrode and a lithium-ion battery cell comprising the pre-lithiated electrode, the method being industrially applicable and allowing efficient and homogeneous transfer of lithium to the electrode without compromising the quality of the electrode.

### BRIEF SUMMARY

One aspect of the present disclosure relates to a method of fabricating a pre-lithiated electrode, comprising:
disposing a Li-PET sheet comprising a layer of lithium metal adjacent to a prefabricated electrode comprising a layer of anode material;
contacting a surface of the layer of anode material with a surface of the layer of lithium metal; and
calendering the layer of lithium metal and the prefabricated electrode together.

In a preferred embodiment in combination with any of the above or below embodiments, the method further comprises separating the PET sheet from the surface of the layer of anode material to form the pre-lithiated electrode.

In a further preferred embodiment in combination with any of the above or below embodiments, the PET layer has a thickness of about 20 μm to about 200 μm, more preferably of about 30 μm to 80 μm, in particular, about 50 μm.

In a further preferred embodiment in combination with any of the above or below embodiments, the PET layer further comprises a release layer.

In a further preferred embodiment in combination with any of the above or below embodiments, the release layer has a thickness of about 0.005 μm to about 2 μm.

In a further preferred embodiment in combination with any of the above or below embodiments, calendering the layer of lithium metal comprises applying uniform pressure to a back surface of the carrier substrate, wherein the uniform pressure is a pressure ranging from about 1.9 MPa to about 8.9 MPa, preferably from about 3.2 MPa to about 5.3 MPa.

In a further preferred embodiment in combination with any of the above or below embodiments, calendering the layer of lithium metal and the prefabricated electrode together comprises transferring the layer of lithium metal and the prefabricated electrode through a pair of calendering rolls.

In a further preferred embodiment in combination with any of the above or below embodiments, the method further comprises heating the front roll to a temperature in the range of from about 40° ° C. to about 75° C., more preferably from about 60° C. to about 70° C., in particular, about 65° C.

In a further preferred embodiment in combination with any of the above or below embodiments, the method further comprises heating the back roll to a temperature in the range of from about 40° ° C. to about 75° C., more preferably from about 60° C. to about 70° C., in particular, about 65° C.

In a further preferred embodiment in combination with any of the above or below embodiments, the prefabricated electrode is a negative electrode comprising a Cu carrier foil.

In a further preferred embodiment in combination with any of the above or below embodiments, the Cu carrier foil has a thickness of about 6 μm to about 12 μm, in particular, about 8 μm.

In a further preferred embodiment in combination with any of the above or below embodiments, the prefabricated electrode is a negative electrode comprising a carbonaceous material, silicon, silicon oxide or combinations thereof.

In a further preferred embodiment in combination with any of the above or below embodiments, the carbonaceous material is selected from natural graphite, artificial graphite, or combinations thereof.

In a further preferred embodiment in combination with any of the above or below embodiments, the prefabricated electrode is a negative electrode having a coating, the coating preferably comprising SiO_{y}C_{z}, wherein y is from 0 to 2 and z is 0 or 1.

In a further preferred embodiment in combination with any of the above or below embodiments, the coating is a double-sided coating.

In a further preferred embodiment in combination with any of the above or below embodiments, the coating has a thickness of about 10 μm to about 80 μm.

In a further preferred embodiment in combination with any of the above or below embodiments, the layer of lithium metal has a thickness from about 3 μm to about 15 μm, more preferably from about 6 μm to about 12 μm, in particular, about 9.3 μm. The lithium layer needs to be passivated, preferably by CO₂.

In a further preferred embodiment in combination with any of the above or below embodiments, the gap between the calendering rolls is from about 160 μm to about 200 μm, preferably from about 170 μm to about 190 μm, more preferably about 180 μm.

Alternatively, the pressure applied to the back surface of the carrier substrate can be defined in kN. In a further preferred embodiment in combination with any of the above or below embodiments, calendering the layer of lithium metal comprises applying uniform pressure to a back surface of the carrier substrate, wherein the uniform pressure is a pressure ranging from about 0.7 kN to about 0.8 kN, preferably about 0.75 kN.

In a further preferred embodiment in combination with any of the above or below embodiments, the method further comprises incorporating the pre-lithiated electrode into an electrochemical cell further comprising a positive electrode, a separator, and an electrolyte.

A further aspect of the present disclosure relates to a lithium-ion battery cell, comprising:
a pre-lithiated electrode formed according to the method according to the present disclosure;
a positive electrode comprising oxides of a metal, preferably a transition metal; and
an electrolyte, wherein the electrolyte is selected from a solid electrolyte, a liquid electrolyte, or a polymer electrolyte.

In a further preferred embodiment in combination with any of the above or below embodiments, each of the pre-lithiated electrode and the positive electrode are in a fully charged position.

In a further preferred embodiment in combination with any of the above or below embodiments, each of the pre-lithiated electrode and the positive electrode are in a partially charged position.

In a further preferred embodiment in combination with any of the above or below embodiments, the pre-lithiated electrode is completely lithiated in the fully charged position and the positive electrode is completely delithiated in the fully charged position.

The present disclosure is not limited to the use of a Li-PET sheet in the claimed method. In more general terms, the present disclosure therefore provides a method of fabricating a pre-lithiated electrode, comprising:
disposing a carrier substrate comprising a layer of lithium metal adjacent to a prefabricated electrode comprising a layer of anode material;
contacting a surface of the layer of anode material with a surface of the layer of lithium metal; and
calendering the layer of lithium metal and the prefabricated electrode together.

In a preferred embodiment in combination with any of the above or below embodiments, the carrier substrate is a PET substrate.

In a further preferred embodiment in combination with any of the above or below embodiments, the carrier substrate is a sheet. The preferred embodiments set out above for claimed method including the use of a Li-PET sheet are also applicable to the method including the use of a carrier substrate.

In a preferred embodiment in combination with any of the above or below embodiments, the method is implemented as a roll-to-roll process. The term “sheet” as used herein is intended to designate a flexible material to which lithium is applied. The term is not limited a specific geometrical shape, such as a layer, but also includes material that is wound into a roll.

### BRIEF DESCRIPTION OF THE DRAWINGS

FIG. 1 illustrates a material flow according to an aspect of the present disclosure.

FIG. 2 depicts steps 1 to 3 of 9 of the pre-lithiation procedure according to an aspect of the present disclosure.

FIG. 3 depicts steps 4 and 5 of 9 of the pre-lithiation procedure according to an aspect of the present disclosure.

FIG. 4 depicts steps 6 and 7 of 9 of the pre-lithiation procedure according to an aspect of the present disclosure.

FIG. 5 depicts steps 8 and 9 of 9 of the pre-lithiation procedure according to an aspect of the present disclosure.

FIG. 6 depicts the adjustment of pressure/temperature in step 4 of the pre-lithiation procedure according to an aspect of the present disclosure.

FIG. 7 depicts pictures relating to table in FIG. 6 showing different levels of homogeneity in application of lithium.

FIGS. 8A-8C show effects of applied pressure on the deviation of thickness, width and length of the electrode at room temperature. Commas within numeral labels in FIGS. 8A-8C should be interpreted as decimal points.

### DETAILED DESCRIPTION

The following describes the claimed method of fabricating a pre-lithiated electrode and the claimed lithium-ion battery cell.

Certain details are set forth in the following description and in the Figures to provide a thorough understanding of various implementation of the present disclosure. Other details describing well-known structures and systems often associated with electrochemical cells and batteries are not set forth in the following to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the scope of the present disclosure.

As used herein, each of the terms “comprising’, “having” and “containing,” including grammatical variants thereof, are meant in a non-exhaustive sense to mean “including,” but not necessarily “composed of,” and does not exclude elements in addition to those explicitly recited as being present. As used herein, then, the terms “comprising,” “having” and “containing,” and grammatical variants thereof, indicate that components other than those explicitly recited may, but need not, be present. As such these terms include as a limiting case embodiments in which no other elements than those recited are present, e.g., in the commonly accepted sense of “consisting of.”

As used herein, the phrase “consisting of,” and grammatically related variants thereof, means that no other elements are present in those recited. In standing with the above definition of “comprising” (and grammatically and semantically related terms), the term “consisting of” therefore denotes a limiting scenario within the meaning of “comprising.”

As used herein, the term “PET” denotes the known polymeric material polyethylene terephthalate. The term “PET” also includes a derivative of PET.

In more general terms, the PET or the derivative of PET can be replaced by a carrier substrate, provided that the carrier substrate is flexible and ensures the adhesion of the lithium layer and its release under pressure, ensures the adhesion of the release layer, is chemically inert with respect to the release layer and lithium, and is stable under pressure in the selected pressure range.

Unless defined otherwise, any feature within any aspect or embodiment of the present disclosure may be combined with any feature within any other aspect or embodiment of the present disclosure. This applies, in particular, to all embodiments described within the section relating to the method of fabricating a pre-lithiated electrode per se, in respect of other aspects, e.g., the lithium-ion battery cell. This also applies, in particular, but not exclusively, to endpoints of ranges disclosed herein.

As used herein the term “about” when referring to a particular value, e.g., an endpoint or endpoints of a range, encompasses and discloses, in addition to the specifically recited value itself, a certain variation around the specifically recited value. Such a variation may, for example, arise from normal measurement variability. The term “about” shall be understood as encompassing and disclosing a range of variability above and below an indicated specific value, the percentage values being relative to the specific recited value itself, as follows. The term “about” may denote variability of +5.0%. The term “about” may denote variability of +4.0%. The term “about” may denote variability of +3.0%. The term “about” may denote variability of +2.0%. The term “about” may denote variability of +1.0%. The term “about.” in reference to the particular recited value, may denote that exact particular value itself, irrespective of any explicit mention that this exact particular value is included; even in the absence of an explicit indication that the term “about” includes the particular exact recited value, this exact particular value is still included in the range of variation created by the term “about,” and is therefore disclosed.

Implementations described herein will be described below in reference to a roll-to-roll coating system. It should also be understood that although described as a roll-to-roll process, the implementations described herein can be performed on discrete substrates.

The pre-lithiation method described herein is applicable to Li-ion batteries using solid electrolytes (e.g., solid-state batteries) as well as Li-ion batteries, which use liquid or polymer electrolytes.

The claimed method involves the pre-lithiation of anode materials with a lithium coated substrate, preferably PET, by way of direct contact. Direct contact is an effective way to pre-lithiate the anode material as this creates excellent surface contact between the lithium and the anode layer. The method described herein can be slotted into current battery production lines.

The carrier substrate for lithium, preferably PET, is a flexible substrate, which can be used in roll-to-roll coating.

The calender rolls must be about 100% cylindrical to ensure uniform pressure distribution. Uniform pressure distribution means a pressure distribution on the surface of no more than +/−5%. The front roll is the roll that points to the subsequent process and the back roll is the roll that points away from the subsequent process.

In a roll-to-roll process, roll is defined as coiled strip material. During the process run, the unwound material is in the process as a strip and can then be separated directly into electrodes or rewound as a roll. This roll can have a cylindrical or substantially cylindrical shape.

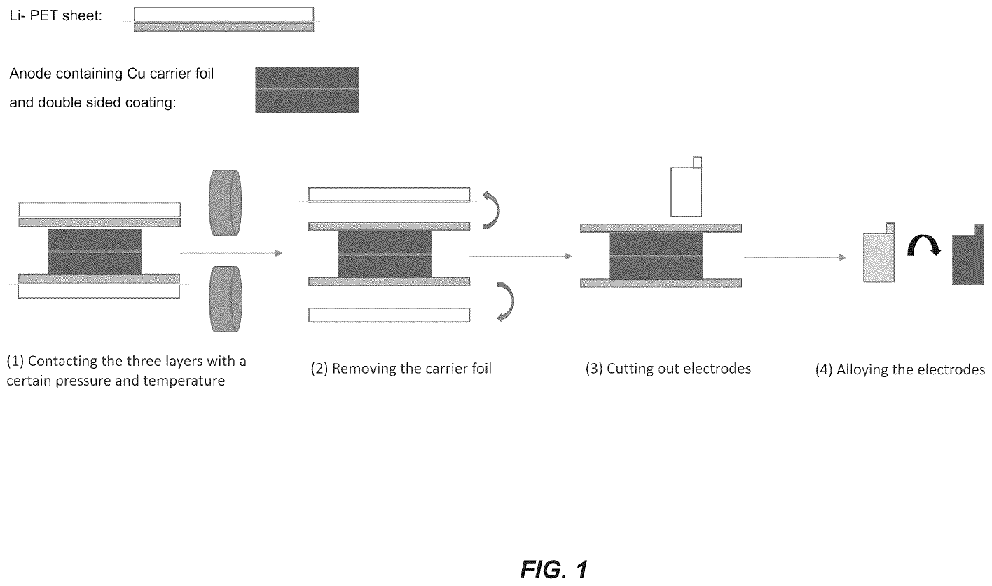

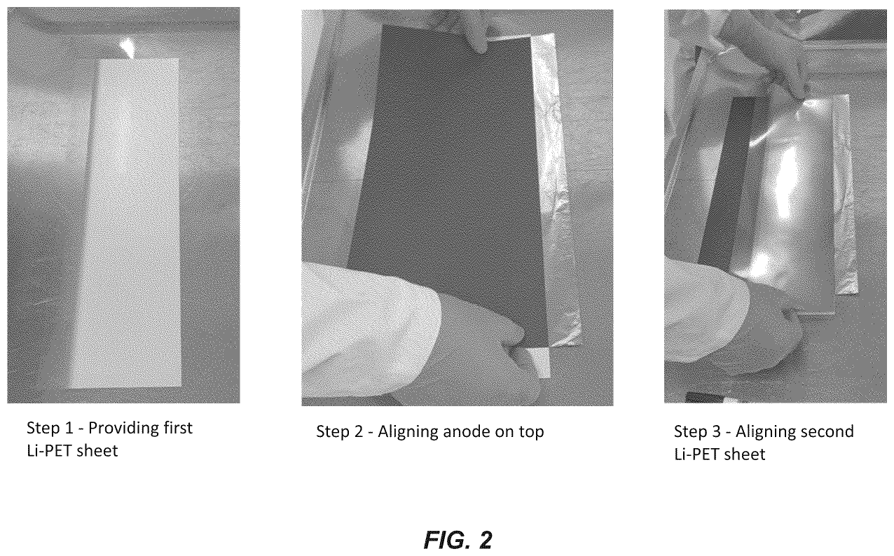

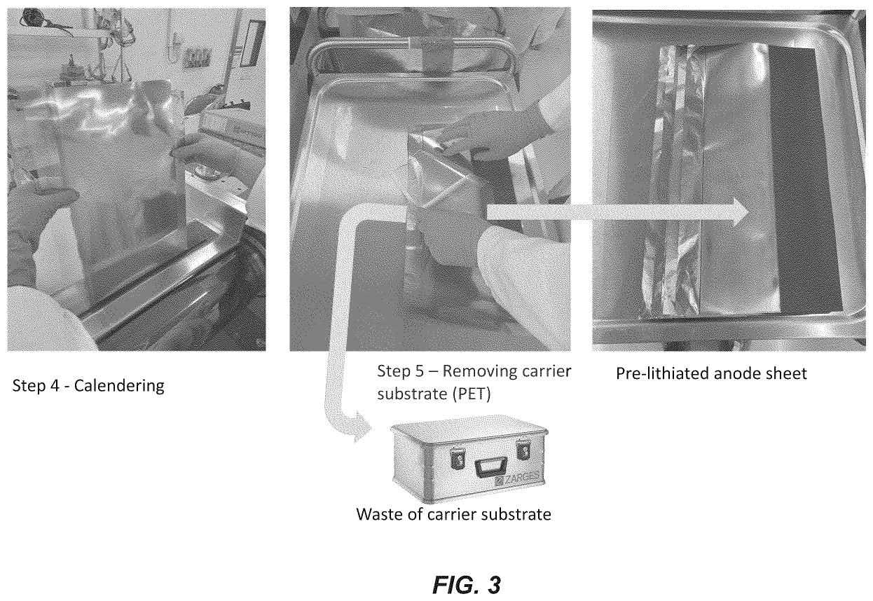

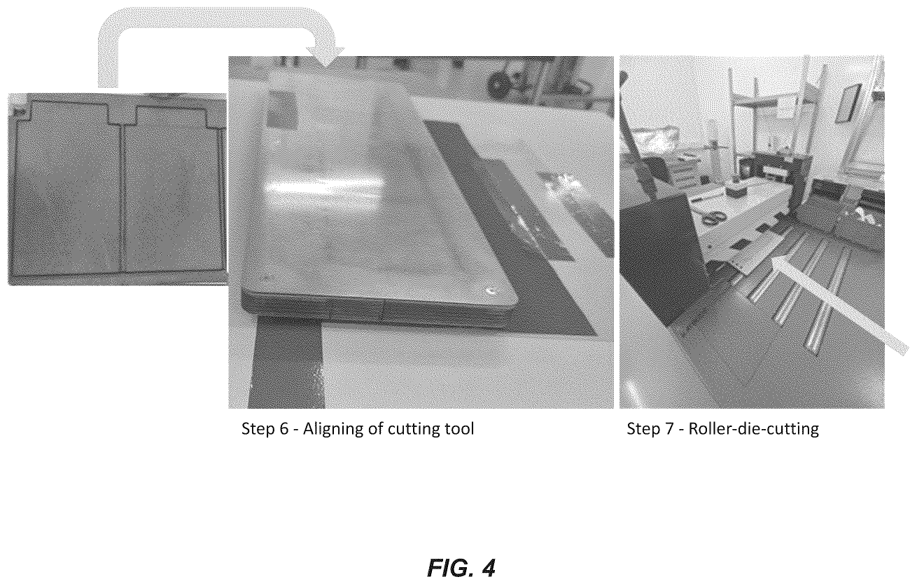

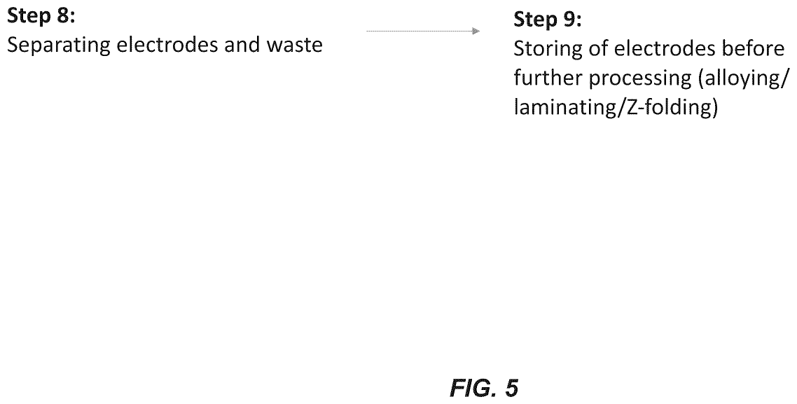

FIG. 1 illustrates a material flow according to the present disclosure. This material flow is further illustrated by pictures in FIGS. 2 to 5. The material flow in FIG. 1 can be correlated to the pictures in FIGS. 2 to 5 as follows:
Step (1) in FIG. 1 shows steps 1 to 4 in FIGS. 2 and 3 in condensed form;
Step (2) in FIG. 1 corresponds to step 5 in FIG. 3;
Step (3) in FIG. 1 shows steps 6 and 7 in FIG. 4 in condensed form; and
Step (4) in FIG. 1 shows steps 8 and 9 in FIG. 5 in condensed form.

As shown in FIG. 1, the Li-PET sheet is pressed to an anode, which is preferably a Cu carrier foil having a double-sided coating containing SiO_{y}C_{z}, wherein y is 0-2 and z is 0 or 1. FIG. 1 shows:
(1) Contacting the three layers with a certain pressure and temperature,
(2) Removing the carrier foil,
(3) Cutting out electrodes, and
(4) Alloying the electrodes.

The steps (1) and (4) of FIG. 1 must be adjusted to achieve the following goals:
The carrier PET foil can be removed according to step (2) of FIG. 1 while ensuring a homogeneous transfer of lithium to the anode;
   The applied pressure in step (1) of FIG. 1 does not lead to:
   A compression of the anode material itself, or
A deformation of the PET foil;
The applied temperature in step (1) does not lead to any decomposition reaction on the anode;
The step (4) of alloying the electrodes is slow enough to be of no risk for the production, to be homogeneous and to allow the cutting of the electrode before the material gets brittle; and
The step (4) of alloying the electrodes is fast enough to remove elemental lithium from the anode surface to allow the follow up processing of the electrode (laminating).

FIGS. 2 to 5 further illustrate the material flow according to FIG. 1 as described above.

FIG. 2 show the provision of a first Li-PET sheet (step 1), the aligning of an anode on top of the first Li-PET sheet (step 2), and the aligning of a second Li-PET sheet on top of the anode to achieve a three-layered structure of Li-PET sheet/anode/Li-PET sheet (step 3).

FIG. 3 shows the calendering of the three-layered structure of Li-PET sheet/anode/Li-PET sheet of FIG. 2 (step 4) and the removal of the carrier substrate (PET) to obtain a pre-lithiated anode sheet (step 5).

The calendering of the three-layered structure of Li-PET sheet/anode/Li-PET sheet according to step 4 is preferably carried out with a front roll having a temperature in the range of from about 40° ° C. to about 75° C., more preferably from about 60° C. to about 70° C., and, in particular, about 65° C., and a back roll having preferably a temperature in the range of from about 40° ° C. to about 75° C., more preferably from about 60° C. to about 70° C., and, in particular, about 65° C. A homogeneous transfer of lithium can, however, also be achieved at room temperature, as discussed below. The friction between the calendering rolls can be within the range of about +/−2%. The sheet is preferably processed through the calendering rolls at a speed that ensures a homogeneous temperature of +/−2° C. The sheet is therefore preferably processed at a speed of about 0.1-5 m/min, more preferably at a speed of about 2 m/min. Alternatively or in addition, the sheet may be pre-heated. Step 4 further preferably comprises applying uniform pressure to a back surface of the carrier substrate, wherein the uniform pressure is a pressure ranging from about 1.9 MPa to about 8.9 MPa, preferably from about 3.2 MPa to about 5.3 MPa. The gap between the calendering rolls in step 4 is preferably from about 160 μm to about 200 μm, more preferably from about 170 μm to about 190 μm, and, in particular, about 180 μm.

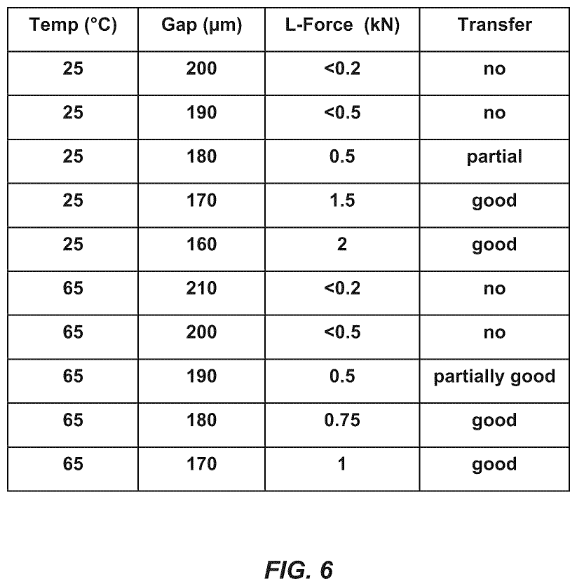

The technical effect of the different parameters temperature, gap and pressure, and their interrelation is further illustrated in FIG. 6. The experiments shown in FIG. 6 aim to achieve complete lithium transfer while keeping the line force as low as possible to avoid any potential damage to the anode material itself, e.g., loss of porosity and thus performance, and to avoid a deformation of the PET foil. It should be understood that the temperature and the gap determine the pressure (expressed as L-force (kN) in FIG. 6).

The table in FIG. 6 shows five experiments at a temperature of 25° C. with decreasing gap widths of 200 μm, 190 μm, 180 μm, 170 μm and 160 μm. The selected temperature and gap widths led to increasing L-forces of <0.2 kN, <0.5 kN, 0.5 kN, 1.5 kN and 2 kN, respectively. Thus, lower gap widths are associated with higher pressures. The column under the heading “Transfer” in FIG. 6 evaluates the transfer of lithium to the anode material. There was no transfer at L-forces of <0.2 kN or <0.5 kN. There was a partial transfer at an L-force of 0.5 kN. There was a good transfer at L-forces of 1.5 and 2 kN.

The table in FIG. 6 further shows five experiments at a temperature of 25° C. with decreasing gap widths of 210 μm, 200 μm, 190 μm, 180 μm, and 170 μm. The selected temperature and gap widths led to L-forces of <0.2 kN, <0.5 kN, 0.5 kN, 0.75 kN and 1 kN, respectively. There was no transfer at L-forces of <0.2 kN or <0.5 kN. There was a partial transfer at an L-force of 0.5 kN. There was a good transfer at L-forces of 0.75 and 1 kN.

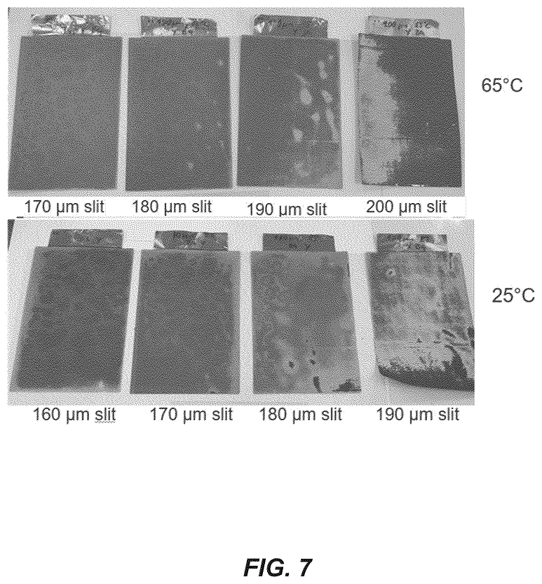

A good transfer of lithium to the anode material is characterized by a high level of homogeneity in the application of lithium, as can be taken from FIG. 7. The pictures in FIG. 7 reveal that the application is homogeneous for experiments conducted at 25° C. with 160 or 170 μm slit (i.e., gap width) or at 65° C. with 170 or 180 μm slit. The experiments demonstrate that the higher the temperature, the lower the pressure required for good transfer.

The experiments shown in FIGS. 6 and 7 were also carried out at temperatures of 40° C., 70° C., and 80° C. 80° C. yielded no transfer at all for the applied gaps and the results at 70° C. were not as good as the results at 65° C. Further, the results at 40° C. lay between the results at 25° C. and at 65° C.

The data in the table of FIG. 6 thus reveals a trend, i.e., the higher the temperature, the lower the pressure needed for good lithium transfer. While four experiments were evaluated to achieve “good” transfer of lithium, such “good” transfer can be achieved e.g., by applying an L-force of only about 0.75 kN at a temperature of about 65° C. This is a surprisingly good result. Both a higher temperature of 70° C. and a lower temperature of 40° C. led to less desirable results, as described above.

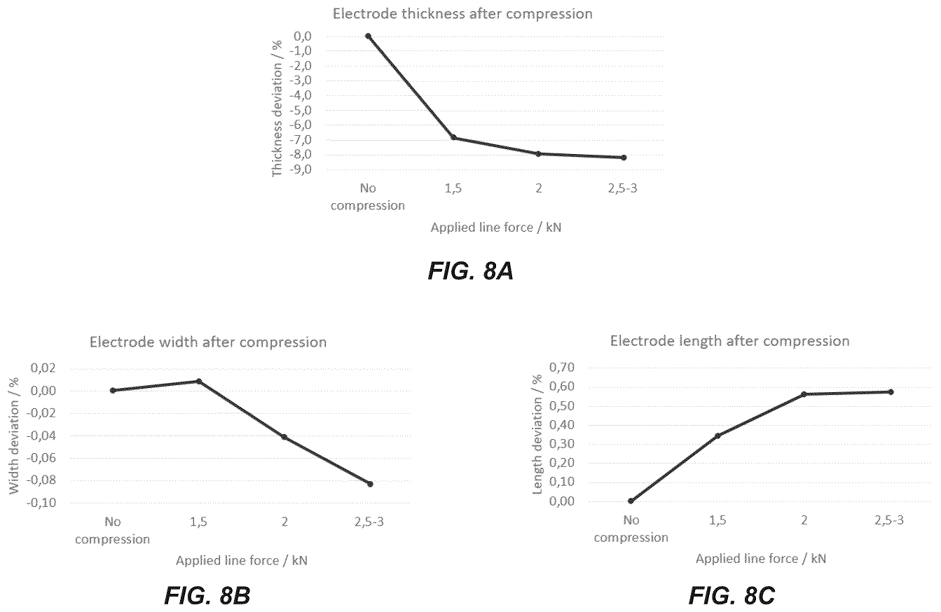

FIGS. 8A-8C show effects of applied pressure on the deviation of thickness, width and length of the electrode at room temperature.

FIG. 8A shows a graph of the electrode compression in terms of thickness deviation in %.

FIG. 8B shows a graph of the electrode width in terms of width deviation in %.

FIG. 8C shows a graph of the electrode length in terms of length deviation in %.

As shown in FIGS. 8A-8C, the effect of compression on the length, width and thickness of the electrode at room temperature is exemplified. The aim is to change the electrode as little as possible. It was found that the width of the electrode remains unchanged by compression up to a pressure of 1.5 kN and then decreases, i.e., is constricted. The length and thickness of the electrode change proportionally to the contact pressure. Therefore, it could be determined that a contact pressure of 1.5 kN causes the fewest geometric changes on the electrode.

As shown in FIG. 6, the pressure can be further reduced by applying the lithium foil at higher temperatures. This reduces the deformation of the electrode, which does not change the properties of the electrode despite pre-lithiation.

Thus, an optimal combination of temperature and pressure respectively gap of the calendering rolls was found to achieve a pre-lithiation process reducing the anode compression, ensuring good application of the lithium foil.

The pre-lithiated anode sheet obtained in step 5 of FIG. 3 is preferably stored for no more than 3 hours before cutting according to step 7 of FIG. 4 (see below) at a temperature in the range from 5 to 20° C., preferably from 5 to 10° C. The storage time of no more than 3 hours is calculated from step 4 of FIG. 3.

FIG. 4 shows the aligning of a cutting tool to the pre-lithiated anode sheet of FIG. 3 (step 6) and the subsequent roller-die-cutting (step 7). The step of cutting is not limited to roller-die-cutting and can be affected by any other suitable cutting technique.

FIG. 5 shows the step of separating electrodes and waste (step 8) and the step of storing the electrodes before further processing (such as alloying/laminating/Z-folding) (step 9).

The alloying time in a step of alloying the electrode is generally in the range from 12 to 72 hours and is preferably in the range from 18 to 28 hours. The alloying temperature can be in the range from 20 to 60° C. and is preferably at about room temperature, as more side reactions occur with higher temperatures. The alloying atmosphere can be a dry room (having a dew point of about)−50° ° C. or a CO₂ atmosphere. The alloying atmosphere should not be any of argon (Ar), nitrogen (N₂) or vacuum, as such an atmosphere would entail too many side reactions.

Summarizing the above, surprisingly, a method of fabricating a pre-lithiated electrode that is industrially applicable was found, allowing an efficient homogeneous transfer of lithium to an anode material without compressing the anode material or leading to any decomposition reaction on the anode. The pre-lithiated electrode can be used as part of a high performance lithium-ion battery cell, which requires high electric current and high energy density.

The present disclosure is further directed to the following embodiments:

1. A method of fabricating a pre-lithiated electrode, comprising:
disposing a Li-PET sheet comprising a layer of lithium metal adjacent to a prefabricated electrode comprising a layer of anode material;
contacting a surface of the layer of anode material with a surface of the layer of lithium metal; and
calendering the layer of lithium metal and the prefabricated electrode together.

2. The method according to embodiment 1, further comprising:
separating the PET sheet from the surface of the layer of anode material to form the pre-lithiated electrode, wherein the PET layer preferably has a thickness of about 20 μm to about 200 μm.

3. The method according to embodiment 1 or embodiment 2, wherein the PET layer further comprises a release layer, the release layer preferably having a thickness of about 0.005 μm to about 1 μm.

4. The method according to any one of embodiments 1 to 3, wherein calendering the layer of lithium metal comprises applying uniform pressure to a back surface of the carrier substrate, wherein the uniform pressure is a pressure ranging from about 1.9 MPa to about 8.9 MPa, preferably from about 3.2 MPa to about 5.3 MPa.

5. The method according to any one of embodiments 1 to 4, wherein calendering the layer of lithium metal and the prefabricated electrode together comprises transferring the layer of lithium metal and the prefabricated electrode through a pair of calendering rolls.

6. The method according to any one of embodiments 1 to 5, further comprising heating the front roll to a temperature in the range of from about 40° C. to about 75° ° C., preferably from about 60° ° C. to about 70° C., in particular, about 65° C.

7. The method according to any one of embodiments 1 to 6, further comprising heating the back roll to a temperature in the range of from about 40° C. to about 75° C., preferably from about 60° C. to about 70° ° C., in particular, about 65° C.

8. The method according to any one of embodiments 1 to 7, wherein the prefabricated electrode is a negative electrode comprising a Cu carrier foil, the Cu carrier foil preferably having a thickness of about 6 μm to about 12 μm.

9. The method according to any one of embodiments 1 to 8, wherein the prefabricated electrode is a negative electrode comprising a carbonaceous material, silicon, silicon oxide or combinations thereof, the carbonaceous material preferably being selected from natural graphite, artificial graphite, or combinations thereof.

10. The method according to any one of embodiments 1 to 9, wherein the prefabricated electrode is a negative electrode having a coating, the coating preferably comprising SiO_{y}C_{z}, wherein y is from 0 to 2 and z is 0 or 1.

11. The method according to embodiment 10, wherein the coating is a double-sided coating and/or has a thickness of about 10 μm to about 80 μm.

12. The method according to any one of embodiments 1 to 11, wherein the gap between the calendering rolls is from about 160 μm to about 200 μm, preferably from about 170 μm to about 190 μm, more preferably about 180 μm.

13. The method according to any one of embodiments 1 to 12, further comprising incorporating the pre-lithiated electrode into an electrochemical cell further comprising a positive electrode, a separator, and an electrolyte.

14. A lithium-ion battery cell, comprising:
a pre-lithiated electrode formed according to the method according to any one of embodiments 1 to 13;
a positive electrode comprising oxides of a transition metal; and
an electrolyte, wherein the electrolyte is selected from a solid electrolyte, a liquid electrolyte, or a polymer electrolyte.

15. The lithium-ion battery cell according to embodiment 14, wherein each of the pre-lithiated electrode and the positive electrode are in a fully charged position, preferably wherein the pre-lithiated electrode is completely lithiated in the fully charged position and the positive electrode is completely delithiated in the fully charged position.

What is claimed is:

1. A method of fabricating a pre-lithiated electrode, comprising:
disposing a Li-PET sheet comprising a layer of lithium metal adjacent to a prefabricated electrode comprising a layer of anode material;
contacting a surface of the layer of anode material with a surface of the layer of lithium metal; and
calendering the layer of lithium metal and the prefabricated electrode together,
the calendering comprising transferring the layer of lithium metal and the prefabricated electrode through a pair of calendering rolls,
the calendering further comprising applying uniform pressure to a back surface of the Li-PET sheet, wherein the uniform pressure is a pressure ranging from about 0.7 kN to about 0.8 kN,
wherein a front roll and/or a back roll is heated to a temperature in the range of from about 40° C. to about 75° C., and
PET denotes polyethylene terephthalate or a derivative of polyethylene terephthalate.

2. The method of claim 1, further comprising:
separating the PET sheet from the surface of the layer of anode material to form the pre-lithiated electrode.

3. The method of claim 1, wherein the PET sheet further comprises a release layer.

4. The method of claim 1, further comprising heating the front roll to a temperature in the range of from about 40° C. to about 75° C.

5. The method of claim 1, further comprising heating the back roll to a temperature in the range of from about 40° C. to about 75° C.

6. The method of claim 1, wherein the prefabricated electrode is a negative electrode comprising a Cu carrier foil.

7. The method of claim 1, wherein the prefabricated electrode is a negative electrode comprising a carbonaceous material, silicon, silicon oxide or combinations thereof.

8. The method of claim 1, wherein the prefabricated electrode is a negative electrode having a coating.

9. The method according to claim 8, wherein the coating is a double-sided coating and/or has a thickness of about 10 μm to about 80 μm.

10. The method of claim 1, wherein a gap between the calendering rolls is from about 160 μm to about 200 μm.

11. The method of claim 1, further comprising incorporating the pre-lithiated electrode into an electrochemical cell further comprising a positive electrode, a separator, and an electrolyte.

12. The method of claim 2, wherein the PET layer has a thickness of about 20 μm to about 200 μm.

13. The method of claim 3, wherein the release layer has a thickness of about 0.005 μm to about 1 μm.

14. The method of claim 6, wherein the Cu carrier foil has a thickness of about 6 μm to about 12 μm.

15. The method of claim 7, wherein the carbonaceous material comprises natural graphite, artificial graphite, or combinations thereof.

16. The method of claim 8, wherein the coating comprises SiO_{y}C_{z}, wherein y is from 0 to 2 and z is 0 or 1.

17. The method of claim 10, wherein the gap between the calendering rolls is from about 170 μm to about 190 μm.

18. The method of claim 17, wherein the gap between the calendering rolls is about 180 μm.

19. A lithium-ion battery cell, comprising:
a pre-lithiated electrode formed according to the method according to claim 1;
a positive electrode comprising oxides of a transition metal; and
an electrolyte, wherein the electrolyte is selected from a solid electrolyte, a liquid electrolyte, or a polymer electrolyte.

20. The lithium-ion battery cell of claim 19, wherein each of the pre-lithiated electrode and the positive electrode are in a fully charged position, preferably wherein the pre-lithiated electrode is completely lithiated in the fully charged position and the positive electrode is completely delithiated in the fully charged position.
